(19) United States
(12) Patent Application Publication
(10) Pub. No.: US 2009/0290942 A1
(43) Pub. Date: Nov. 26, 2009

(54) Pneumatic Conveyor for Suspended Articles with Support Beam for Conveyor Accessories

(75) Inventors: Pascal Delaporte, Seclin (FR); Pascal Deleporte, Faches Thumesnil (FR)

Correspondence Address: HARNESS, DICKEY & PIERCE, P.L.C., P.O. BOX 828, BLOOMFIELD HILLS, MI, 48303, US

(73) Assignee: NETRA SYSTEMS, Marcq En Baroeul (FR)

(21) Appl. No.: 11/795,740

(22) PCT Filed: Nov. 17, 2005
(86) PCT No.: PCT/FR05/02852

§ 371 Date: Apr. 3, 2008

(30) Foreign Application Priority Data
Jan. 20, 2005 (FR) 0500563

(51) Int. Cl. B65G 51/03

(52) U.S. Cl. 406/88

(57) ABSTRACT

The pneumatic conveyor permits the transport of articles suspended by means of air jets and comprises an article suspension and guide rail (6) and a support beam (7), mounted in a parallel manner at a level below that of suspension and guide rail (6), permitting the fitting of conveyor accessories. The beam (7) is preferably adjustable for height (direction Y) and supports guiding means (11) for the articles. Said guiding means (11) are particularly embodied as guides (11a) the lateral position (direction X) of which is adjustable.

### FIELD OF THE INVENTION

The present invention relates to the field of transport, by means of air jets, of light suspended articles, such as empty plastic containers (bottles, flasks, preforms, etc.). In this field, it relates to a pneumatic conveyor equipped with new means for the fitting of conveyor accessories, and in particular (but not exclusively) the fitting of guiding means for the transported articles. More particularly, these new fitting means permit, if necessary, an easier adjustment of the position (in height and/or transversally to the direction of transport) of the conveyor accessories.

### PRIOR ART

To date, for the transport of light articles, such as for instance hollow plastic containers (bottles, flasks, etc.), it is known to use pneumatic conveyors, which are equipped with a suspension and guide rail on which the articles are suspended, and with means enabling transport air jets to be generated onto the articles and for the suspended articles to be propelled along the suspension and guide rail.

In practice, regarding more particularly the transport of plastic containers such as bottles or flasks, the articles are most often suspended by a projection of their neck, commonly known as a flange, and the suspension and guide rail consists of two parallel and spaced-apart profiles, commonly known as “under-neck guides”.

In a pneumatic conveyor for suspended articles, the generation of transport air jets is achieved by means of at least one blower box, which is supplied with compressed air by at least one fan and which comprises a plurality of blow-out openings or slits. These blow-out openings or slits are distributed along the path of the articles and enable the compressed air inside the box to escape, in the form of a plurality of transport air jets aimed at the articles. Depending on the type of pneumatic conveyor, these transport air jets can be generated such that they are directed onto the articles, underneath and/or above and/or in the region of their suspension point (i.e. their flange in the case of bottles, flasks or preforms).

By way of example of the prior art in the field of pneumatic conveyors for suspended articles, the following publications in particular can be cited: U.S. Pat. No. 5,542,789, U.S. Pat. No. 5,246,314, WO-A-9746472, FR-A-2 767 517, WO-A-2004/067420, WO-A-2004/096680 and EP-A-0 705 777.

In pneumatic conveyors for suspended articles, it is also known to implement conveyor accessories, which enable the transport of articles to be improved or controlled.

A first known type of conveyor accessories consists of additional guiding means, which enable the tilting of the transported articles to be mechanically limited. These guiding means play an important role in the conveying of suspended articles.

In particular, it is usual to equip the pneumatic conveyor with lateral guides mounted on either side of the path of the articles. These lateral guides are positioned at a height below the level of the article suspension and guide rail (under-neck guides) and enable the article to be guided at the level of its body below its suspension point (flange). The lateral guides enable the lateral swinging of the transported articles to be limited, and thus enable the risks of blocking or unhooking of the articles during transport to be limited. In certain cases, the conveyor comprises several pairs of lateral guides, each arranged at two levels of different height.

It is also known to equip a conveyor with a pair of guides called “longitudinal guides”, which are positioned at such a height as to limit the tilting of each article in its direction of transport. A conveyor equipped with this type of guide is for instance described in French patent application FR-A-2 767 517. More particularly, FIG. 1 of this publication illustrates a conveyor equipped with a pair of longitudinal guides (upper guides referred to by “7”) and a pair of lateral guides (lower guides referred to by “6”).

Generally, these additional guiding accessories (lateral guides or longitudinal guides) are fitted to the blower box or supported at ground level, by means of a plurality of vertical supports distributed along the guiding accessory. Reference can be made for instance to U.S. Pat. No. 5,542,789 (FIGS. 1 to 6).

In the aforementioned pneumatic conveyors of the prior art, it is understood that the format of the transported articles determines the positioning of the guiding accessories. More particularly, the space between the lateral guides, or between the longitudinal guides, depends on the size of the articles in their contact region with these guides (for instance the diameter of the bottles). Similarly, the distance of the guides with regard to the suspension point of the articles (i.e. the height of the guides) depends on the format and, in this case, on the height of the transported articles.

On the same conveyor, therefore, if one wishes to transport articles of different formats, it is indispensable that the position of the guiding accessories for height and/or laterally (in particular the adjustment of the space between the guides) can be easily, rapidly and precisely adjusted.

With this aim in view, various solutions have to date already been suggested in publications U.S. Pat. No. 5,542,789, WO 2004/067420, WO 2004/096680.

In patent U.S. Pat. No. 5,542,789, the solution for adjusting the position of each guide consists in using jacks transversely directed towards the guide and spaced regularly along the guide. The main disadvantage of this solution is that it imposes the implementation of a large number of jacks—in practice one jack for each metre of the conveyor and this for each guide—making it costly. Another result of this solution is that, in order to minimise the cost, pneumatic jacks must be used with two or three positions, and from an economic point of view it is not feasible to use multi-position jacks of the electrical jack type. Because of this, the options for adjusting the position of these guides are very limited.

Patent application WO 2004/067420 suggests a different solution enabling the position of the lateral guides of a pneumatic conveyor to be adjusted, both in height and laterally, by means of jack-like actuators. This solution is extremely costly, taking into account the high number of jacks required (in practice one pair of jacks per guide for each metre of the conveyor).

Patent application WO 2004/096680 suggests a different solution for adjusting the lateral position of a conveyor accessory and in particular of lateral guides of a pneumatic conveyor. Compared with the aforementioned solutions, this solution presents the advantage of reducing the number of jack-like actuators that are implemented and, as a result, is less costly.

Pneumatic conveyors for the transport of plastic or similar bottles also exist, such as for instance the conveyor described in European patent application EP-A-0 705 777, equipped with a cover over the articles (walls referred to by “9” in document EP-A-0 705 777) and/or air deflection elements (deflector walls referred to by “12” in document EP-A-0 705 777). It is of interest to have a simple and flexible solution for the fitting of these accessories on the conveyor and, if necessary, for the adjusting of the position of these accessories in order in particular to best adapt this position to the format of the transported articles.

It is furthermore also usual to equip the pneumatic conveyor with sensors (photocells, ultrasound sensor, etc.), which can detect the presence and possibly the speed of the articles at different points of the pneumatic conveyor. Because of this, it is of interest to have a simple and flexible solution for the fitting of these accessories at different positions along the conveyor. In addition, the position on the pneumatic conveyor of this type of accessory also depends on the format of the transported articles and must, as a result, preferably be easily adjustable.

### OBJECT OF THE INVENTION

The main object of the invention is to provide a new technical solution, which simplifies and makes more flexible the fitting of conveyor accessories on a pneumatic conveyor for the transport of suspended articles.

A further object of the invention is to provide a new technical solution, which enables the position adjustment of conveyor accessories to be simplified, such as in particular guiding accessories, so as to make the pneumatic conveyor a multi-format one.

### SUMMARY OF THE INVENTION

The object of the invention is a pneumatic conveyor, which enables the transport of suspended articles by means of air jets and which comprises a suspension and guide rail for articles.

According to the invention, the pneumatic conveyor characteristically comprises a support beam, which is mounted in a substantially parallel manner to and at a level below that of the suspension and guide rail and which enables conveyor accessories to be fitted.

More particularly, the conveyor according to the invention comprises the following additional and optional characteristic features, taken in isolation or in combination with one another:

the support beam is positioned below the path of the articles and is preferably centred in relation to the suspension and guide rail;

the beam comprises attachment means enabling the fitting on the beam of at least one conveyor accessory at different positions along the beam; more particularly, the attachment means comprise at least one longitudinal rail; preferably, the beam is hollow and comprises at least one longitudinal opening, the beam walls on either side of the said longitudinal opening forming the attachment rail; the longitudinal opening of the beam is preferably a longitudinal attachment slit, which extends along the entire length of the beam;

the conveyor comprises at least one conveyor accessory mounted on the support beam; preferably, at least one conveyor accessory mounted on the support beam consists of guiding means for the articles; preferably, said guiding means comprise two guides that are substantially parallel to the suspension and guide rail;

the conveyor comprises first adjustment means for the position of the guiding means, in a plane substantially parallel to the suspension plane of the suspension and guide rail and in a transversal direction (X) substantially perpendicular to the conveying direction of the articles;

said first adjustment means are supported by the beam;

said first adjustment means comprise at least one actuator, the motor axis of which is oriented essentially according to the longitudinal direction (Z) of the beam;

said first adjustment means comprise a linear jack-like actuator; preferably, the motor axis of the linear actuator is oriented essentially parallel to the longitudinal direction (Z) of the beam, and the first adjustment means comprise movement transmission means, which are interposed between the actuator and the guiding means for the articles, and which enable the longitudinal translation movement of the motor axis of the actuator to be transformed into a translation movement in a direction (X) transversal to the conveying direction of the articles; more particularly, said movement transmission means comprise a rotary disc and at least one articulated link;

said guiding means comprise at least one guide, and said first adjustment means comprise for each guide at least two movable supports connecting the guide to the beam, which are spaced apart along the beam and which are actuated simultaneously by the same actuator;

said guiding means comprise two guides substantially parallel to the suspension and guide rail and said first adjustment means enable a simultaneous adjustment of the position of the two guides one in relation to the other (spacing apart or coming together of the guides);

the conveyor comprises second adjustment means for adjusting the position in height of the beam;

said second adjustment means comprise at least one linear jack-like actuator;

the conveyor comprises a blower box on which the suspension and guide rail for the articles is fitted and the beam is suspended on this blower box.

### BRIEF DESCRIPTION OF DRAWINGS

Other characteristic features and advantages of the invention will appear more clearly upon reading the detailed description hereinafter of a preferred embodiment of a pneumatic conveyor according to the invention, said description being given by way of a non-limiting and non-exhaustive example of the invention and with reference to the figures, in which:

FIGS. 1 and 2 are two perspective views of one same section of a pneumatic conveyor, from different view angles,

FIG. 3 is a cross-section of the basic plan of the conveyor of FIGS. 1 and 2 in a plane perpendicular to the conveying direction of the articles,

FIG. 4 is a perspective view of the support beam of the conveyor of FIGS. 1 and 2 and of its height adjustment means (direction Y),

FIG. 5 is a side view of the support beam and of its height adjustment means (direction Y),

FIG. 6 is a perspective view of the support beam of the conveyor of FIGS. 1 and 2 and of the additional guiding means, which are supported by this beam and which comprise two guides,

FIG. 7 is a cross-section of the basic plan of FIG. 6 overall, in a plane perpendicular to the conveying direction of the articles,

FIG. 8 is a perspective view of the jack used to adjust the conveyor guides in a lateral position (direction X), as well as the means connecting this jack on the one hand with the beam 7 (not represented in FIG. 8) and on the other hand with a control rod (not represented in FIG. 8),

FIG. 9 is a view from below of the adjustment means for spacing apart (direction X) the two guides of the conveyor in a first adjustment position corresponding to a maximum spacing apart of the guides, and

FIG. 10 is a view from below of the adjustment means for spacing apart (direction X) the two guides of the conveyor in a first adjustment position corresponding to a minimum spacing apart of the guides.

### DETAILED DESCRIPTION

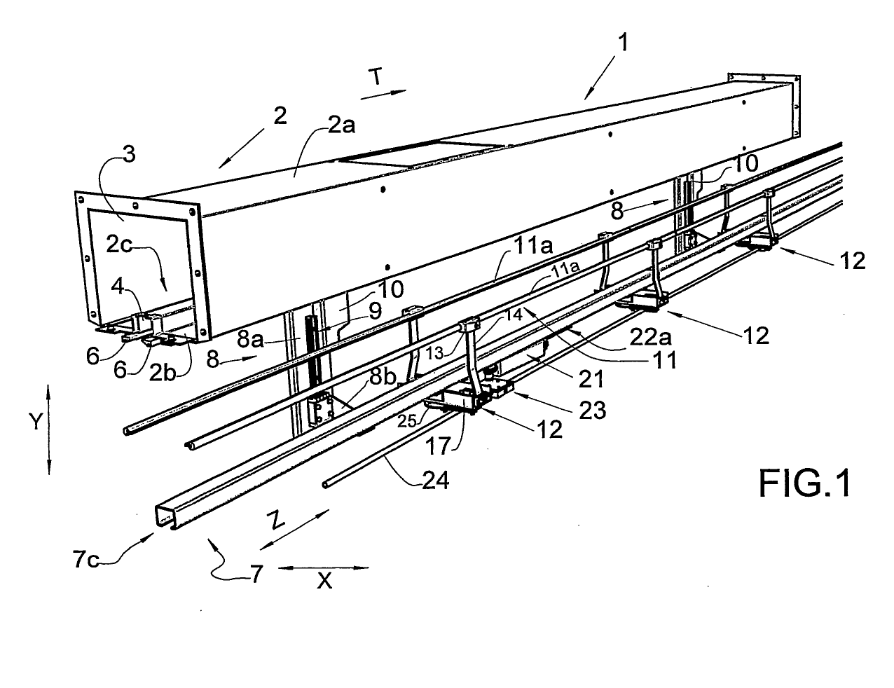

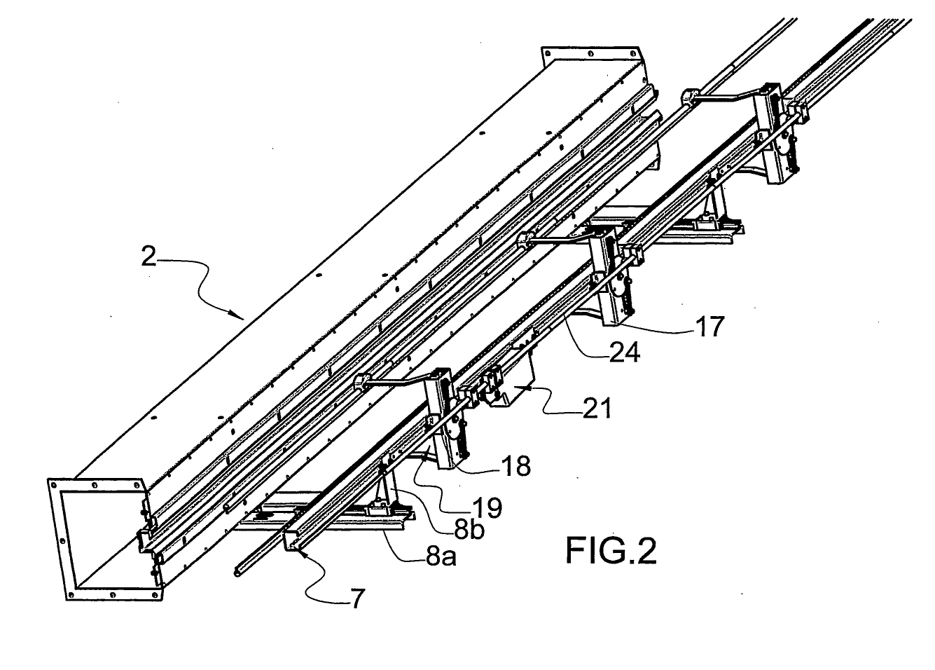

FIGS. 1 and 2 show a rectilinear section of a pneumatic conveyor for the transport, by means of air jets, of suspended articles of the hollow and empty plastic container type comprising a flange (bottles, flasks, preforms, . . . ). In a well-known manner, a pneumatic conveyor is formed of a plurality of sections mounted end-to-end, of which certain sections may be curved, according to the layout of the conveyor line.

This section of pneumatic conveyor comprises a sheet-metal box 2 consisting of a U-shaped part 2a, which is closed by a bottom panel 2b. This box 2 forms a support structure either by being supported at ground level by legs or equivalent (not represented) and/or by being fitted to a vertical wall and/or a ceiling.

The interior volume of the box 2 consists of a chamber 3 (commonly called “plenum”), which when in operation is intended to be supplied with compressed air by means of fans (not represented) suitably distributed along the length of the conveyor.

In the particular embodiment illustrated on the annexed drawings, the panel 2b is a metal sheet shaped such that it comprises a central recess 2c defining a longitudinal blower channel 4. The chamber 3 and the blower channel 4 communicate via the blow-out slits 5, which are located in the lateral walls of the recess 2c and which are suitably distributed along the length of the conveyor.

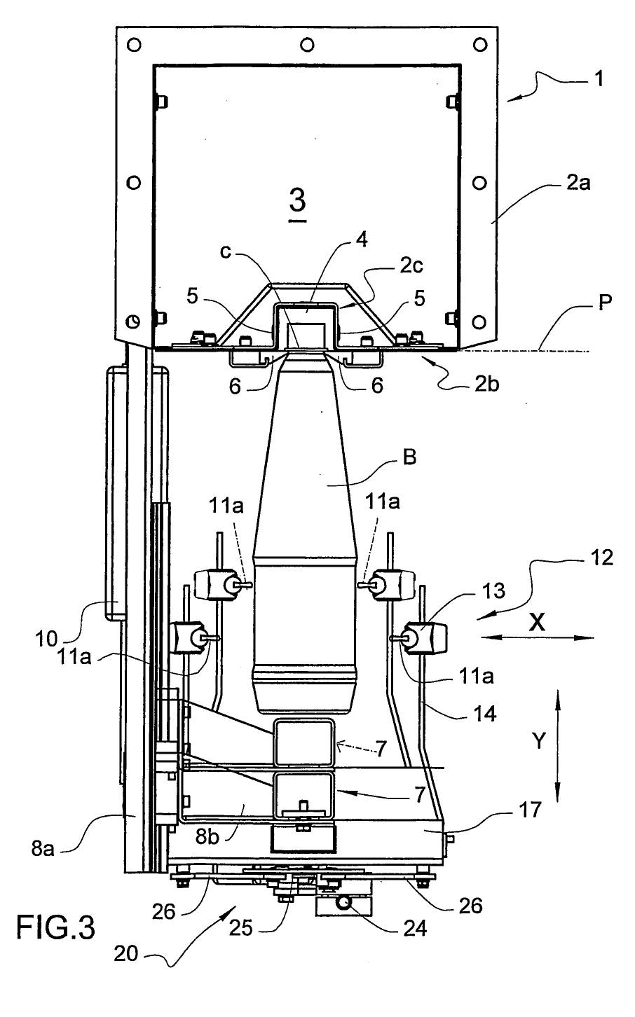

On the lower side of the panel 2b are fitted, by any appropriate means, two under-neck guides 6, for instance made of plastic, which are spaced apart and parallel, so as to form a suspension and guide rail for the articles along the conveyor. In FIG. 3, the suspension plane defined by the two under-neck guides 6 is referenced with P.

With reference to FIG. 3, the conveyor enables for instance empty plastic bottles B (or equivalent), which are suspended on the two under-neck guides 6 via their flange C, to be transported.

When in operation, the compressed air inside the chamber 3 escapes into the blower channel 4 via the blow-out slits 5, in the form of a plurality of transport air jets, which are distributed along the length of the conveyor and which are directed onto the bottles (in the particular example illustrated, above their flange C) and which enable the bottles to be propelled in line one after the other, in the transport direction T.

The structure of the pneumatic conveyor just described with reference to the annexed drawings is not limitative of the invention. The system of the invention, of which a preferred embodiment will now be described with reference to the annexed drawings, and which enables the fitting and, if necessary, the adjustment in position of conveyor accessories (in particular additional guiding means), can be implemented for any type of pneumatic conveyor permitting the transport of suspended articles by means of air jets.

In accordance with one feature of the invention, the pneumatic conveyor section 1 comprises a support beam 7, which enables conveyor accessories to be fitted in different positions along the conveyor. This beam 7 is mounted substantially parallel to the under-neck guides 6 and is positioned at a level lower than these under-neck guides 6. It extends substantially along the entire length of the conveyor.

More particularly, in the illustrated example, with particular reference to FIG. 3, the beam 7 is positioned underneath the path of bottles B, directly below the under-neck guides 6. Preferably, but not necessarily according to the invention, the beam 7 is centred in relation to the suspension and guide rail formed by the under-neck guides 6.

In the preferred embodiment of the annexed drawings, the beam 7 is suspended from the box 2 by means of fitting supports 8 distributed along the beam. In another alternative, the beam 7 could be supported at ground level via supports distributed along the beam.

In the particular example illustrated, this beam 7 comprises at least one rigid hollow profile, for instance made of a metal, presenting in cross-section an unclosed contour, with a longitudinal slit 7a extending along the entire length of the beam 7. In practice, the beam will consist of the end-to-end assembly of several profiles, joined for instance by welding, the essential being that each portion of the beam 7 between two successive supports 8 possesses sufficient rigidity to be used as an attachment support for conveyor accessories.

The walls 7b of the beam on either side of the slit 7a form a longitudinal attachment rail 7c with this slit. More particularly, in the illustrated example, the beam 7 presents in cross-section a C-shaped profile and the attachment rail 7c is arranged in its lower wall.

The invention is not limited to the particular beam structure of the annexed drawings. In particular, the invention is not limited to a support beam displaying the particular profile in cross-section of the beam 7 of the annexed drawings, but can be implemented with any type of beam profile in cross-section. In a further alternative, the beam can be solid. The attachment rail 7c could be a mounted rail fitted to the beam. The beam can comprise several attachment rails. The attachment rail 7c can be replaced by any equivalent fitting means enabling the easy fitting on the support beam of conveyor accessories at different positions along the conveyor. For instance, the longitudinal attachment slit 7a can be replaced by a plurality of shorter slits or slits with oblong orifices, which are aligned and distributed along the length of the beam 7. In the curved portions of the conveyor, the beam is not rectilinear but curved and follows the path of the articles.

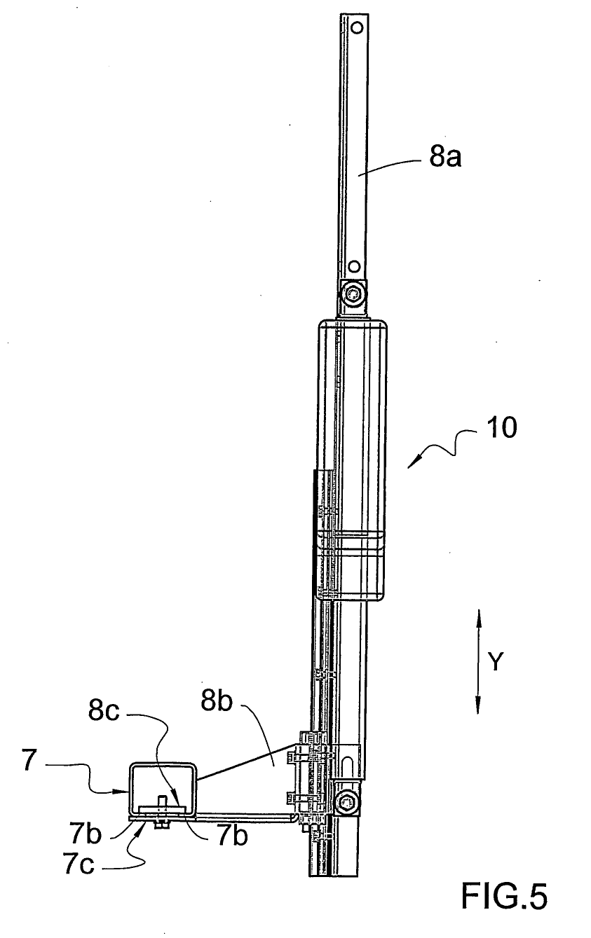

Each fitting support 8 of the beam 7 comprises a vertical pillar 8a and a mounting bracket 8b. The vertical pillar 8a is fitted by any appropriate means to one of the lateral walls of the box 2. The bracket 8b ensures the link between the pillar 8a and the beam 7. More particularly, with reference to FIG. 5, the bracket 8b is attached to the longitudinal rail 7c of the beam 7 and fitted to the beam 7 by locking means 8c.

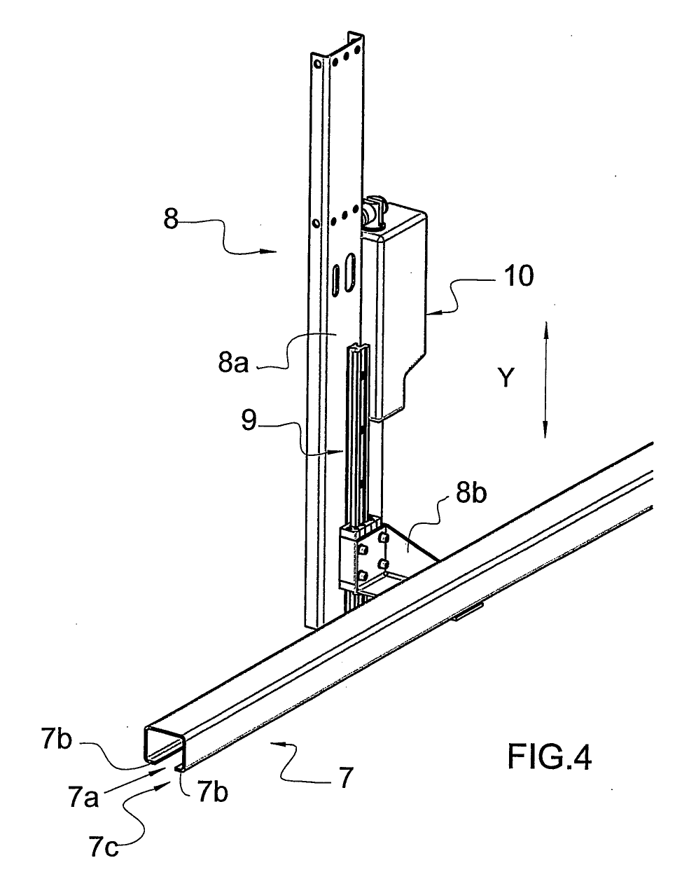

According to a preferred characteristic of the invention, the vertical distance between the beam 7 and the under-neck guides 6, i.e. in other words the position in height of the beam 7, is adjustable. For that purpose, in the example illustrated in the drawings (see in particular FIGS. 4 and 5), each bracket 8b is mounted to slide on a fixed vertical rail 9, which is secured to the pillar 8a. In addition, on each pillar 8a a linear jack-like actuator 10 is mounted, permitting the corresponding bracket 8b to slide on its rail 9. The result is thus an easy and rapid adjustment of the position in height of the support beam 7 (position adjustment according to direction Y/FIGS. 1, 4 and 5). In an advantageous manner, a jack 10 can be foreseen every three metres or more of the conveyor, for instance.

The pneumatic conveyor section 1 is equipped with additional guiding means 11, which are supported solely by the support beam 7 and which, as a result, are movable in a vertical translation with this beam 7.

In the example illustrated, these additional guiding means 11 comprise two parallel and spaced-apart guide bars 11a, which extend parallel to the under-neck guides 6 and which are arranged on either side of the path of the bottles B (FIG. 3).

Each guide bar 11 a is linked to the beam 7 via a plurality of support assemblies 12, which are spaced along the beam 7. On FIGS. 1 and 2, three support assemblies 12 are shown.

More particularly, each support assembly 12 comprises a jaw 13, which on the one hand grips in situ a guide bar 11a and which on the other hand is fitted to the extremity of a support piece 14 in the shape of an L. Each L-shaped support piece 14 is fitted to a movable plate 15, which is mounted to slide on a rail 16. The rail 16 is fitted in a U-shaped profile 17, and permits a translational guiding of the guide 11a in a plane substantially parallel to the suspension plane P of the under-neck guides 6, and in a direction substantially perpendicular to the under-neck guides 6 (FIG. 3/adjustment direction X).

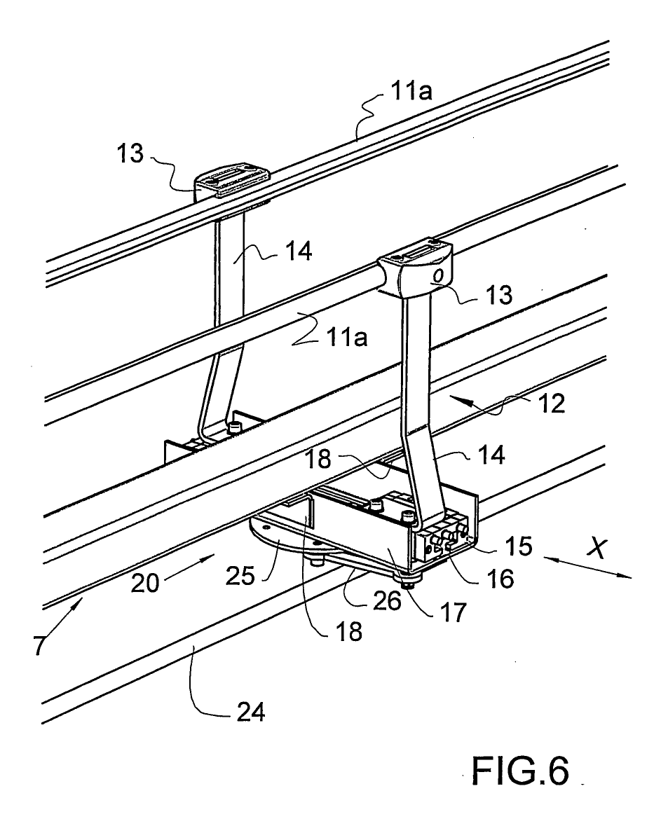

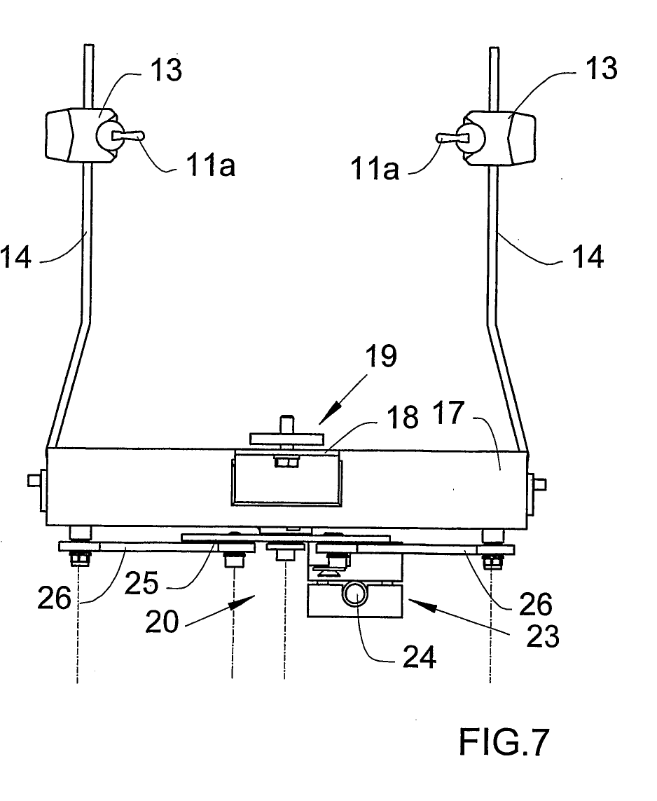

The U-shaped support profile 17 is attached and fitted in position to the guide rail 7c of the beam 7 via brackets 18 (FIGS. 2 and 6), equipped with a system of fitting by locking 19 (FIGS. 2 and 7).

Due to the attachment rail 7c of the support beam 7, the support assemblies 12 of the guide bars 11a can be advantageously adapted on the support beam 7 at any position along the beam, conferring greater flexibility in the choice of position for these support assemblies 12.

In order to enable a position adjustment of the two guides 11a in the direction X, the conveyor furthermore comprises adjustment means 20, which are mounted on the beam 7.

A preferred embodiment of these adjustment means 20 will now be described in more detail, taking into account that this preferred embodiment is not limitative of the invention.

In this preferred embodiment, the adjustment means 20 comprise a linear jack-like actuator 21.

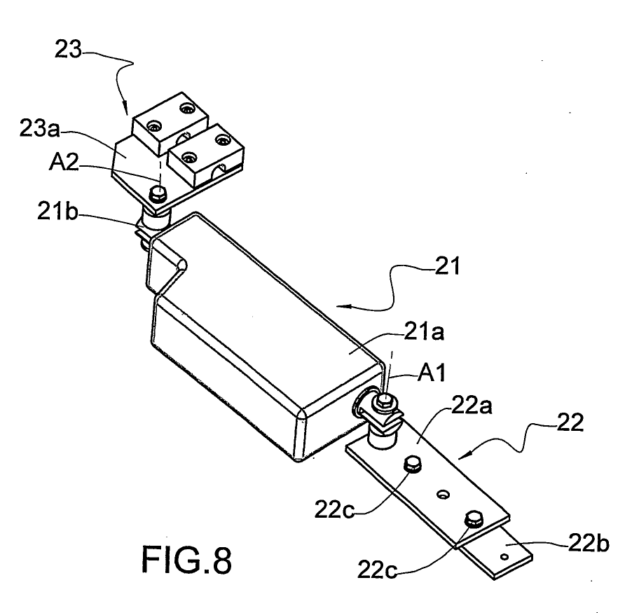

The body 21a of the jack 21 is attached and fitted to the rail 7c of the beam 7 via connecting means 22, which are inserted and fitted into the beam 7 by tightening. These connecting means 22 essentially comprise two plates 22a and 22b linked to one another by spacers 22c (FIG. 8), enabling the rail 7c to be tightened between the two plates 22a and 22b. The body 21a of the jack is rotatably articulated according to the axis A1 (FIG. 8) with regard to the connecting plate 22a. Since the jack 21 is attached to the rail 7c, it can easily be installed in a flexible manner at any position along the beam 7.

The bar 21b (motor axis) of the jack 21 is fitted on connecting means 23 comprising a movable plate 23a, the extremity of the bar 21b being rotatably articulated according to the axis A2 (FIG. 8) with regard to said plate 23a. This movable plate 23a is fitted to a connecting rod 24, which extends essentially in parallel to the beam 7.

Each support assembly 12 comprises, for its lateral position adjustment (direction X), a rotary disc 25, which is fitted under the U-shaped support 17 and which is rotatably mounted with regard to the support 17, according to a rotation axis R substantially perpendicular to the suspension plane P of the under-neck guides 6 (substantially vertical rotation axis R). Two diametrically opposed connecting links 26 are mounted on this disc 25. Each connecting link 26 connects the disc 25 to the sliding plate 15 of the support assembly 12, via a transversal orifice 27 arranged in the lower wall of the U-shaped support 17. Each connecting link 26 is rotatably articulated at its two extremities with regard to the disc 25, or the sliding plate 15.

Each link 26 enables the rotation movement of the disc 25 to be transformed in one direction or the other into a translation movement of the corresponding plate 15 in the adjustment direction X. More particularly, at each rotation in one direction or the other of the disc 25, the links 26 simultaneously transmit opposing translation movements (guided by the fixed rail 16) to the plates 15 in the same adjustment direction X, but in opposite directions. Thus, according to the direction of rotation of the disc 25, the aforementioned guides 11a move away from one another or simultaneously move towards one another in a symmetrical manner with regard to the median vertical plane between the two guides 11a.

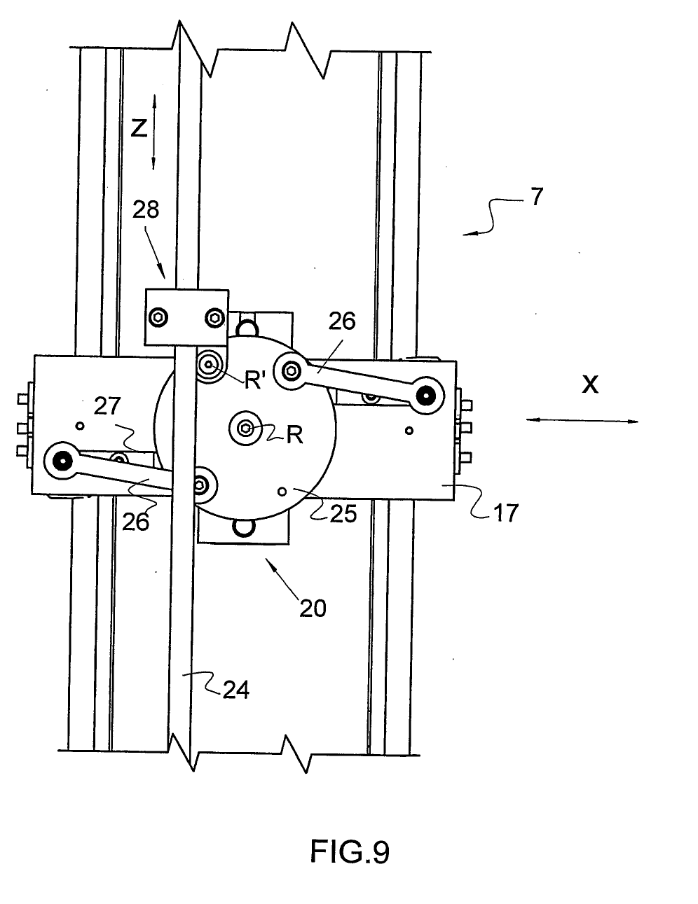

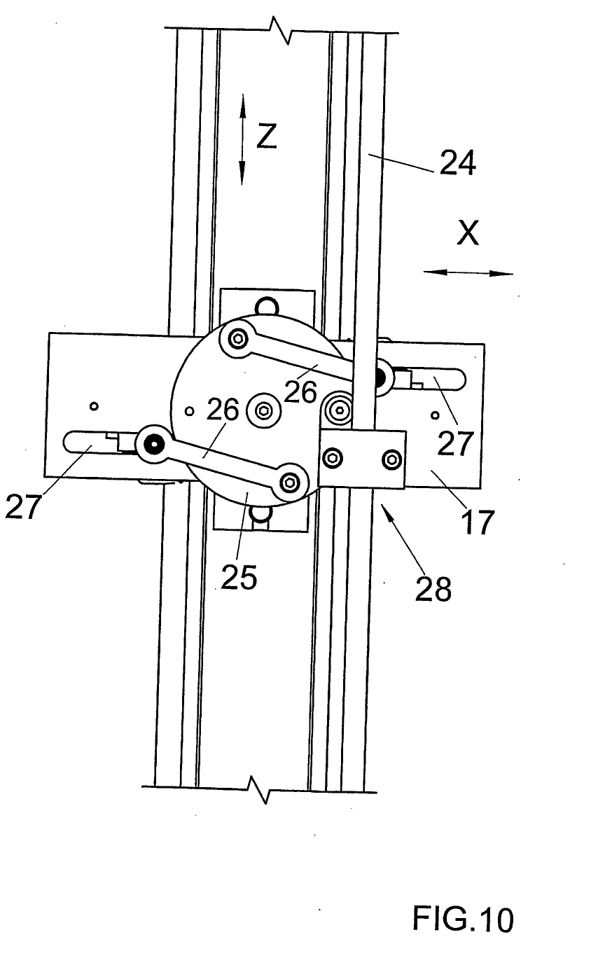

With reference to FIGS. 9 and 10, the rod 24 is linked to the rotary disc 25 by at least one support assembly 12, via a rotatably articulated connection 28 (axis R′) with regard to the disc 25. Thus, the translation of the bar 21b of the jack 21 enables the rod 24 to be translated in the longitudinal direction Z of the conveyor (in one direction or the other). This translation movement of the rod 24 enables the disc 25 to be pivoted in one direction or the other according to the axis R and, because of this, it enables the lateral positions (direction X) of the two guides 11a to be simultaneously adjusted.

Preferably, as illustrated in FIGS. 1 and 2, the rod 24 is linked to the disc 25 by several support assemblies 12, which advantageously limits the number of jacks 21. For instance, a jack 21 can be foreseen every six to nine metres of the conveyor.

In an advantageous manner, since the guides 11 are movable and guided in translation in the aforementioned adjustment direction X, they can be easily adjusted in position, by means of jacks 21, according to the diameter of the transported bottles, in the region of contact with the guides 11a (FIG. 3).

Also, in an advantageous manner, the aforementioned guides 11a are mounted on the beam 7, the position in height of Which is adjustable such that the position in height of the guides can be easily adjusted (adjustment direction Y) by means of the aforementioned jacks 10 so as to be adapted to the format and, in this case, to the height of the transported bottles (FIG. 3).

The possibilities of adjustment in the aforementioned directions X and Y of the guides 11a advantageously enable a multi-format conveyor to be obtained, permitting the transport of bottles of varying formats, the position in X and/or in Y of the guides 11a being adjusted on a case-by-case basis according to the format of the bottles that are to be transported. The different adjustment positions in X and/or Y can for instance be stored in the memory of an electronic command unit (programmable industrial controller, microcontroller, microprocessor, etc.) of the jacks, so as to completely automate the position adjustment (X and/or Y) of the guides 11a according to the bottle format. This bottle format is for instance detected by an operator by means of a communication interface (screen, keyboard) of the command unit. In a semi-automated variation, the operator can also pilot the jacks 10 and 21 in a separate manner by separate commands of the push-button type, for instance, and by visually controlling the instant position in X and/or Y of the guides 11a.

The jacks 10 and/or the jacks 21 are advantageously electrical jacks enabling a very high number of adjustment positions in X and/or Y to be obtained. In a simpler variation, when an adjustment in position X and/or Y of the guides 11a is needed with a more limited number of positions (for instance two or three different positions to transport two or three different bottle formats), it is in this case possible to replace the electrical jacks by jacks of the pneumatic type with two or three positions.

To adjust the guides 11a in the lateral position X, the invention is not limited to the adjustment means 20, which have been described with reference to the annexed drawings. The jacks 21 can in particular be replaced by jacks the bar of which is essentially oriented in the transversal adjustment direction X; this solution nevertheless presents the disadvantage, in comparison with the solution described with reference to the drawings, of increasing the number of jacks required for the adjustment in X.

Also, in a different embodiment of the invention, not automated and purely manual, the jacks 10 and/or 21 could be replaced by manually activated adjustment means.

In a further, simpler embodiment, the beam 7 can be non-movable in height (with no possibility of adjusting the position of the guides 11a in the direction Y). In a further simpler embodiment, the space between the guides 11a cannot be changed (with no possibility of adjusting the conveyor in the lateral direction X).

The support beam 7 can advantageously be used to fit other conveyor accessories to the conveyor, and in particular conveyor accessories where the position in height (direction Y) is dependent on the format of the transported bottles. For instance, the beam 7 can be used as a fitting support for detection means of the bottles (photocells or any other equivalent sensor). Due to the fitting rail 7c of the beam 7, these detection means can advantageously be mounted at any position along the conveyor.

1-22. (canceled)

23. A pneumatic conveyor permitting the transport of suspended articles by means of air jets and including a suspension and guide rail for the articles, comprising a support beam, which is mounted in a substantially parallel manner and at a level below that of the suspension and guide rail, and which permits conveyor accessories to be fitted.

24. The conveyor according to claim 23, wherein the support beam is positioned below the path of the articles.

25. The conveyor according to claim 23, wherein the beam is centred with regard to the suspension and guide rail.

26. The conveyor according to claim 23, wherein the beam comprises attachment means enabling at least one accessory to be fitted on the beam at different positions along the beam.

27. The conveyor according to claim 26, wherein the attachment means include at least one longitudinal rail.

28. The conveyor according to claim 27, wherein the beam is hollow and includes at least one longitudinal orifice, the walls of the beam on either side of the said longitudinal orifice forming the attachment rail.

29. The conveyor according to claim 28, wherein the longitudinal slot of the beam is a longitudinal attachment slit, which extends along the entire length of the beam.

30. The conveyor according to claim 29, wherein the beam in cross-section displays an unclosed contour.

31. The conveyor according to claim 23, further comprising at least one conveyor accessory mounted on the support beam.

32. The conveyor according to claim 31, wherein at least one conveyor accessory mounted on the support beam consists of guiding means for the articles.

33. The conveyor according to claim 32, wherein the guiding means comprise two guides substantially parallel to the suspension and guide rail.

34. The conveyor according to claim 31, further comprising first means for adjusting the position of the guiding means in a plane substantially parallel to the suspension plane of the suspension and guide rail and in a transversal direction substantially perpendicular to the conveying direction of the articles.

35. The conveyor according to claim 34, wherein the first adjustment means are supported by the beam.

36. The conveyor according to claim 35, wherein the first adjustment means include at least one actuator, the motor axis of which is essentially oriented according to the longitudinal direction of the beam.

37. The conveyor according to claim 34, wherein the first adjustment means include a linear jack-like actuator.

38. The conveyor according to claim 37, wherein the motor axis of the linear actuator is oriented essentially parallel to the longitudinal direction of the beam, and the first adjustment means include movement transmission means, which are interposed between the actuator and the guiding means for the articles and which permit the transformation of the longitudinal translation movement of the motor axis of the actuator into a translation movement in a direction transversal to the conveying direction of the articles.

39. The conveyor according to claim 38, wherein the movement transmission means include a rotary disc and at least one articulated link.

40. The conveyor according to claim 34, wherein the guiding means include at least one guide and wherein the first adjustment means include, for each guide, at least two movable supports, which link the guide to the beam, and which are spaced apart along the beam, and which are simultaneously activated by the same actuator.

41. The conveyor according to claim 34, wherein the guiding means include two guides substantially parallel to the suspension and guide rail and wherein the first adjustment means permit a simultaneous adjustment of the position of the two guides with regard to one another (moving away or moving together of the guides).

42. The conveyor according to claim 23, further comprising second adjustment means for adjusting the position in height of the beam.

43. The conveyor according to claim 42, wherein the second adjustment means include at least one linear jack-like actuator.

44. The conveyor according to claim 23, further comprising a blower box on which is fitted the suspension and guide rail for the articles, and wherein the beam is suspended on this blower box.
